(19) United States
(12) Patent Application Publication
(10) Pub. No.: US 2021/0307416 A1
(43) Pub. Date: Oct. 7, 2021

(54) HERMAN LEVEL (4) DISPOSABLE ANTIVIRAL AND ANTIBACTERIAL FULL HEAD AND SHOULDER HOOD

(71) Applicant: Herman Lessey, Benson, NC (US)

(72) Inventor: HERMAN LESSEY, SR., Benson, NC (US)

(21) Appl. No.: 16/839,668

(22) Filed: Apr. 3, 2020

(51) Int. Cl. A41D 13/11; A41D 13/05

(52) U.S. Cl. CPC A41D 13/1153; A41D 13/1184; A41D 2500/50; A41D 13/055; A41D 2200/20; A41D 13/1161

(57) ABSTRACT

The present invention relates to a lightweight comfortable disposable antiviral and antibacterial full head and shoulder hood designed to be pulled over the head of a person and used in conjunction with any N95 mask, surgical mask, paper mask or any other similar protective mask to cover the entire face, head and shoulder of the wearer to eliminate or reduce the rate of viral contamination. Which mask comprises a unitary shell of transparent plastic, or latex, or any similar nylon material. The hood has a cap portion with a two face eye piece opening for the wearing of any eye protection apparatus, and a voicemitter port opening to accommodate the wearing of the N95 mask or any similar protective device. It seals the opening around ear, and the nose and mouth area where the N95 mask or any similar mask is worn. When the hood is use, the ridge of the eye and nose vent is designed to trace the facial respiratory line, from the tip of the nose to midpoint between the ear and mouth, making the mask sturdy when been used, and maintaining the contour of the face depending on the size of the hood. The face plate as three elastic openings that elastically seals the eye opening of the wearer and any protective device used to cover the nose and mouth. The hood also has as a mesh opening around both area of the hears of the wearer head, to facilitate better hearing and provide for air venting of the hood. The collar portion of the hood extend down from the cap portion and includes a Velcro band to slightly adjust the constriction of the neck portion to adjust for proper fit. While the neck and shoulder cape portions projects down from the neck portion and includes a pair of underarm straps having a Velcro material for holding the cape portion in place when hood is been worn. Several Velcro mounds are attached to the collar portion and cape for securing the cape portion upward, when ventilation under the hood is needed.

### BACKGROUND OF THE INVENTION

This invention relates to a disposable antiviral, antibacterial full head and shoulder hood, which is worn in conjunction with an N95 mask, surgical mask, paper mask or any similar disposable protective mask, and or disposable protective gowns and or protective eyewear. The hood is designed to be used one's then discarded. It's especially suitable for the fight against the Corona Virus, and especially appropriate for all front line responders, like medical Doctor's, Nurses, emergency responders, firefighters, police officers and any one currently involve in the frontline global fight against the Corona Virus. It's also suitable for military applications and all civil emergency situation where highly toxic substances are in the atmosphere, like, airborne bacteria and viruses that causes infection and disease through nasal inhalation's and other mucus area of the head.

The most common protective mask been used in Hospital by first responders against the fight of the Corona Virus is the N95 mask and other similar disposable protective equipment. And according to the manufactures of the medical respirator N95, this protective mask is approximately 95% efficient against most airborne bacteria; however our study show that when the N95 mask is used in conjunction with Herman Level (4) hood, the efficient rate increase by 3 to 4 percent. Over the years most protective hood were designed and or constructed for general use without regards to exact fit around the eye's, ears and nose cup or mouth, and or neck or shoulder protection, or were attach as a hood or chemical suit and overalls and were not disposable. Due to the very infectious and contagious nature of the Corona Virus, first responders and those who are required to work directly in such infected atmosphere for prolong period of time must have a fitted hood that completely cover their heads and designed to provide maximum protection when worn with the N95 disposable mask or similar protective devices such as eye disposable eyewear, to minimize the rate infection. Some of the very high infection rate of the Corona Virus in most hospital amongst the first responders, is been cause by faulty and improperly fitted protective mask and or gear that causes cross contamination among the staff. If the N95 or similar disposable mask are not seal around the nose and mouth and eyes during use then the rate of infection among first responders will continue to increase. Most if not all hoods on the market today are not designed to me worn with the N95 mask, they are generic hood and does not provide the kind of seal around the nose, mouth, eyes and ears, and do not cover other membrane of the head to reduce the rate of the Corona Virus infection. These generic hoods are also not disposable.

In view of the aforementioned difficulties of the presently utilized generic hoods or nets, or no hood been used by first responders with their N95 mask, there is an immediate need for a cost effective new and improved disposable protective antiviral, antibacterial full head and shoulder hood, which is designed to be worn in conjunction with an N95 mask, surgical mask, paper mask or any similar disposable protective mask and or disposable protective gowns, nurses or doctors uniform, police or firefighter inform or civilian clothing and protective eyewear. The cost to produce these clear lightweight disposable Herman Level 4 hood is very cost efficient, estimated at peenies per disposable hoods.

### SUMMARY OF THE INVENTION

It is an object of this invention to provide a new and improved lightweight, cost efficient, disposable antiviral and antibacterial full head and shoulder hood designed to be used in conjunction with any N95 mask, surgical mask, paper mask or any other similar protective mask and or eyewear protection, this new hood cover the entire face, head and shoulder of the wearer with a fitted fit around the eyes, nose, mouth and neck, to eliminate or reduce the rate of contamination of the Corona Virus among first responders or anyone involve in the frontline fight against Covid 19. It offers a better seal around the mask and eyewear and provide additional protection to the membrane of the ear and the upper body of the wearer reducing the rate of bacterial infection.

In view of these objects and other objects, this inventions contemplates a new and improved disposable antiviral, antibacterial full head and shoulder hood, which is convenient to be worn in combination with an N95 mask, surgical mask, paper mask or any similar disposable protective mask and or with any disposable protective gowns and or protective eyewear. Having a protective hood, a face portion with two fitted eye piece opening, to accommodate a protective eyewear worn either below the mask or above, and depending on the eyewear model it's either fitted or sealed around the eye piece. And voicemitter port opening to accommodate the wearing of the N95 mask or any similar protective device, worn either below the mask or above its surface The face plate having three elastic openings that elastically seals the eye opening of the wearer and seals the opening of the nose and mouth area where the N95 mask or any similar mask device is used to cover the nose and mouth. When the mask is use the ridge of the designed traces the facial respiratory line, from the tip of the nose to the midpoint between the ear and mouth, making the mask sturdy when been used keeping the contour of the face depending on the size. The face plate as three elastic openings that elastically seals the eye opening of the wearer and the protective device been used to cover the nose and mouth. The hood also having a mesh opening around both hears of the wearer head to facilitate better hearing and air ventilation of the hood. The collar portion of the hood extend down from the cap portion and includes a Velcro band to slightly adjust the constriction of the neck portion, while the neck/shoulder cape portions projects down from the neck portion and includes a pair of underarm straps having a Velcro material for holding the cape portion in place. Several Velcro mounds are attached to the collar portion and cape for securing the cape portion up, when ventilation under the hood is needed. The collar portion includes extended position Velcro pads for adjustment, so that the collar can be slightly constricted around the neck of each wearer for proper fit and seal.

The head and shoulder hood of the present invention is comfortable to wear, inexpensive to manufacture and very safe against airborne contaminants of the Corona Virus. When use as instructed by first line responders in conjunction with the N95 mask, the rate of infection among first responders can be greatly reduce. The potential for infection is also greatly reduce among first responders when the hood is used in conjunction with N95 mask, proper eye protector, and any cover suits or clothing. The Herman hood is was especially designed to be used by all medical personnel, firefighters, medical emergency responders, police department, the military, general usage, and anyone who need and additional layer of protection during the care and treatment of patients in this Global war against the Corona Virus Pandemic.

The cap portions 1, neck portions 5, and the cape portions 6 are integral, and are made of a any lightweight clear plastic material or polymers such as latex, nitrile rubber, neoprene and the like. Nylon machine stitching and permanent liquid adhesive are used to attached, or secure or join any pattern pieces or straps. The face piece nose mouth opening is designed to fit any N95 mask or similar disposable protective mask. The face piece 1, also includes two mesh cover, over each ear 4, that are made of a water proof fiberglass or polyester material. And the neutral fit of the hood allows the wearer to readily and easily remove hood from the head and face. The hood comes in a variety of size including, small, medium, large and extra large.

### DESCRIPTION OF THE DRAWINGS

FIG. 1 Perspective view of the front of the preferred embodiment of the Hood of the present invention.

### DETAILED DESCRIPTION OF THE INVENTION

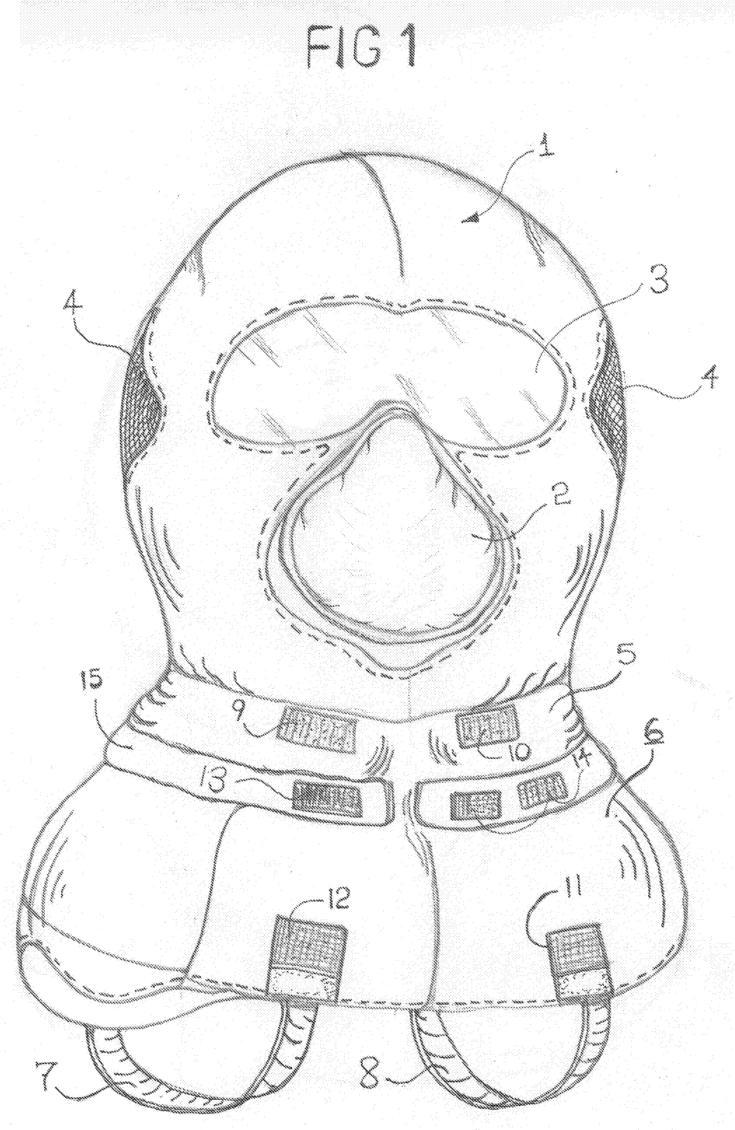

Referring now to FIG. 1 There is disclosed The Herman level 4 disposable antiviral and antibacterial full head and shoulder hood, designated by the number (1) which fits over or under of an N95 mask 2, and the eye protection googles of the hood 3. A raised eye fitted protection lenses aperture 3. An ear barrier mesh cover for ventilation and better earing 4. The hood can be worn fitted above or below the eye protection lenses, or N95 mask.

The Herman Level 4 Hood 1, is designed primarily to be used in all Hospital environment, but can be used in any situation were people need protection from any viral contamination. The hood is comprised of a cap portion 1, having a two piece fitted opening at 3, for wearing the N95 mask, and having an opening at 2 for receiving the N95 mask, and a barrier mesh around the ears at 4. The face piece 2, and 3, are fitted to their apertures to be sealed around its periphery to the border of its openings.

Extending down from the head portion of the hood 1, is a neck portion 5, and extending down from the neck portion is a cape portion 6, the cape portion 6 drapes over the wearer shoulder and is held in place by a pair of underarm plastic Velcro straps 7, straps 7 and 8 are each made of an reinforce plastic fabric material and each include stretch band for comfort. These Velcro straps 7 and 8 are anchored to the rear portion of the cape 6. And are adjustable to more or less 7 to 10 inches.

To allow for ventilation while wearing the hood, and not having to remove the hood, the hood can be raised in place above the shoulder while wearing it. To do this, the first and second Velcro patches 9 and 10 are secured to the cape portion 6 so that the cape portion can be raised and adhered to Velcro hook patches 12 and 11 on the lower portion of the cape 6, the attachment is just below the opening for the N95 mask 2.

Most generic hoods are secured about the wearers neck with a draw cord which can be very difficult to remove or loosen in times of emergency and requires many steps to loosen before and after donning the hood. The hood 1 invention uses Velcro straps 13, an 14 to secure and or adjust the correct fitting to the wearers neck. These plastic straps are anchored to collar 15, the straps are made of a any plastic material and are attaches to a Velcro tab, 13 and 14 that are secured to the Velcro collar 15, on hood 1.

The Herman Level 4 hood 1 invention and without departing from the spirit and scope there of, the forgoing description and drawing of the invention are illustrative and are not be taken as limiting. Still other variation and modification are possible without departing from the spirit and scope of the present invention.

What is claimed:

1. The Herman level 4 disposable antiviral and antibacterial full head and shoulder hood designs to be worn with any N95 or similar mask and any fitted eye protection devise, further comprising earing and ventilation mesh covers to facilitate better earing and ventilation said hood is comfortable lightweight disposable and fully adjustable the apparatus completely cover the head and shoulder of the wearer and further having the means to secure said hood to the head and shoulder of the user.

2. A hood apparatus as in claim 1, wherein a underarm plastic Velcro straps consisting of two single piece straps, having ends which are secured at the rear end of the cape portion of the hood four to six inches above the edge of said cape, and the two extended Velcro end tabs attached to each end of straps for securing the hood to the collar.

3. A hood apparatus as in claim 1, further comprising a face piece secured within the face of the cap portion having two opening in the face of the mask at eye level for the wear of eye protection wherein said eye visors can be worn above or below the eye opening of the hood comprising:
(a) a cape portion that extends over the shoulders of the wearer, the cape portion having a pear of underarm plastic straps secured to the rear of the cape, and having elasticized means for allowing the straps to extend.
(b) a collar portion that is integral to the cap portion, the collar portion having a Velcro belt associated therewith for constricting the collar portion to attain a comfortable fit around the neck.
(c) having a cap portion with a face piece opening around the eyes and nose and a Velcro cover over the both ear location for ventilation and earing.

4. A hood apparatus as in claim 1, wherein the hood is made of any lightweight or food grade clear plastic material or polymers such as latex, nitrile rubber, neoprene and the like, where Nylon or other similar material is use for machine stitching, with permanent liquid adhesive used to attached, secure, or join any pattern pieces, folded edges or straps.

5. A hood apparatus as in claim 1, wherein the hood as two mesh cover placement over the ears of the wearer made of any water resistant fiberglass material, nylons or the like, to allow for better hearing and ventilation.

6. A hood apparatus as in claim 1, wherein a Velcro means is used to secure the collar portion to the cape portion for securing the cape portion to the collar for quick ventilation.

7. A hood apparatus as in claim 1, wherein a easy slip over head and shoulder hood covering, further a having size category to accommodate different body sizes, adapted to cover the head of the user and to extend over the shoulder of the wearer to cover and protect the wearers head and shoulder completely.
